(19) United States
(12) Patent Application Publication
(10) Pub. No.: US 2019/0128723 A1
(43) Pub. Date: May 2, 2019

(54) MEASURING DEVICE AND MEASURING SYSTEM

(71) Applicants: Hirotoshi ISHIDA, Tokyo (JP); FUJITSU COMPONENT LIMITED, Tokyo (JP)

(72) Inventors: Hirotoshi ISHIDA, Tokyo (JP); Akio NAKAMURA, Tokyo (JP); Katsuya FUNAKOSHI, Tokyo (JP); Tatsushi SHIBUYA, Tokyo (JP); Maiko KIKUCHI, Tokyo (JP); Takashi ARITA, Tokyo (JP); Eiji YUMOTO, Tokyo (JP); Mitsuhiro SEKIZAWA, Tokyo (JP)

(73) Assignees: Hirotoshi ISHIDA, Tokyo (JP); FUJITSU COMPONENT LIMITED, Tokyo (JP)

(21) Appl. No.: 16/151,687

(22) Filed: Oct. 4, 2018

(30) Foreign Application Priority Data
Oct. 27, 2017 (JP) 2017-208601

(51) Int. Cl. G01F 22/00; G01G 23/48; G01G 19/415; G08B 21/18; B65D 25/20

(52) U.S. Cl. CPC G01F 22/00; G01G 23/48; B65D 25/20; G08B 21/182; G01G 19/415

(57) ABSTRACT

A measuring device includes: a holding device that holds a container containing a measured object detachably; a measuring unit that measures a weight of the container or a volume of the measured object; a calculation unit configured to calculate an amount of use of the measured object based on the weight or the volume measured by the measuring unit and a last measurement result by the measuring unit; and a communication device that transmits the amount of use of the measured object to an external terminal.

### CROSS-REFERENCE TO RELATED APPLICATION

This application is based upon and claims the benefit of priority of the prior Japanese Patent Application No. 2017-208601 filed on Oct. 27, 2017, the entire contents of which are incorporated herein by reference.

### FIELD

A certain aspect of the embodiments is related to a measuring device and a measuring system for measuring a measured object in a container. The measuring device and the measuring system may be used for measuring the intake of a measured object such as medicine when the measured object contained in a container is drunk.

### BACKGROUND

In recent years, there has been known a system that puts tablets in a dedicated case and provides a specified amount of medicine at an appropriate time as disclosed in, for example, Japanese Patent Application Publication No. 2013-220240. This system prevents a patient from forgetting to take medicine or mistaking the type or amount of medicine to be taken, and allows a patient or a doctor to manage medication. Additionally, there has been known a cup that measures the intake when a liquid in a container is drunk.

### SUMMARY

According to an aspect of the present invention, there is provided a measuring device including: a holding device that holds a container containing a measured object detachably; a measuring unit that measures a weight of the container or a volume of the measured object; a calculation unit configured to calculate an amount of use of the measured object based on the weight or the volume measured by the measuring unit and a last measurement result by the measuring unit; and a communication device that transmits the amount of use of the measured object to an external terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of an intake measuring system 9 including an intake measuring device 1 in accordance with an embodiment;

FIG. 2A is a cross-sectional view of the intake measuring device 1, and FIG. 2B is a bottom view of the intake measuring device 1 as viewed from below;

FIG. 3A is a configuration diagram of a control board 15, and FIG. 3B is a configuration diagram of an external terminal 4;

FIG. 4A illustrates the state of a container 2 when a capacitance sensor 25 is used, and FIG. 4B illustrates the state of the container 2 when an optical sensor 26 is used;

FIG. 5 is a schematic view of a cross-section of the intake measuring device 1;

FIG. 6A is a schematic cross-sectional view of a first variation of the intake measuring device 1, and FIG. 6B through FIG. 6D illustrate the state of a rotary holding member 55 from the mounting of the container 2 to the removal of the container 2;

FIG. 7A is a schematic cross-sectional view of a second variation of the intake measuring device 1, and FIG. 7B through FIG. 7D illustrate the state of a sliding holding member 60 from the mounting of the container 2 to the removal of the container 2;

FIG. 8 is a flowchart illustrating processes executed by the intake measuring device 1 and the external terminals 4 and 5;

FIG. 9 is a flowchart illustrating the processes executed by the intake measuring device 1 and the external terminals 4 and 5;

FIG. 10A illustrates load-output voltage characteristics of a pressure sensor 13, and FIG. 10B illustrates an example of table data defining the relationship among output voltage, temperature, and load;

FIG. 11 illustrates coefficient data for correcting a tilt; and

FIG. 12 is a flowchart illustrating a process executed by the intake measuring device 1 using the capacitance sensor 25 or the optical sensor 26.

### DESCRIPTION OF EMBODIMENTS

In the case of liquid medicines or liquid nutritional supplements, since there is no dedicated case, the management of medication and ingestion is more difficult than that in the case of tablets. For example, when a cup for measuring the intake of a liquid medicine is used, the liquid medicine needs to be moved into the cup, and the cup needs to be washed after the liquid medicine is drunk. Thus, when the cup for measuring the intake is used, burdensome work is required.

In addition, when a liquid medicine is taken at home, the patient may forget to take medicine, and medication may not be appropriately managed.

Hereinafter, a description will be given of an embodiment of the present invention with reference to the accompanying drawings.

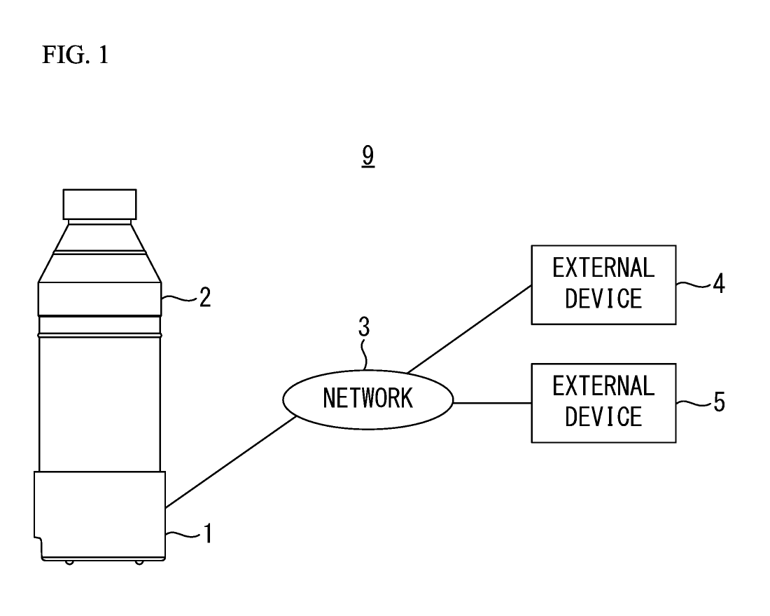

FIG. 1 is a block diagram illustrating a configuration of an intake measuring system, which is an example of a measuring system, including an intake measuring device in accordance with an embodiment. The intake measuring system of the present embodiment measures the intake of a measured object such as a liquid medicine in a container, and manages the ingestion of an ingested object based on the measured intake. When the ingested object is a medicine, a predetermined amount of medicine needs to be taken at a predetermined time or at predetermined time intervals. Thus, intake management of the measured object, medication management including the time of ingestion or time intervals for ingestion, and management of the remaining amount of the measured object are very important. Additionally, although a detailed description is omitted below, it is possible to prevent erroneously ingesting the ingested object that have been left for a long period of time after the ingested object was opened by measuring the time such as an elapsed time after the ingested object was opened, and it is also possible to prevent discarding the ingested object that can be still ingested because the time when the ingested object was opened is uncertain.

The intake measuring system 9 in FIG. 1 includes an intake measuring device 1 and external terminals 4 and 5. The intake measuring device 1 is coupled to the external terminals 4 and 5 via a network 3. The intake measuring device 1 is attachable to a disposable container 2 such as a plastic bottle, measures the intake of a liquid measured object such as a liquid medicine contained in the container 2, and transmits measurement results to the external terminal 4. The intake measuring device 1 is used while being kept attached to the container 2 until the measured object in the container 2 is completely drunk. The external terminal 4 is a computer including a database in which, for example, the measurement results of the intake are recorded. The external terminal 5 is an information processing device such as a computer or a smartphone.

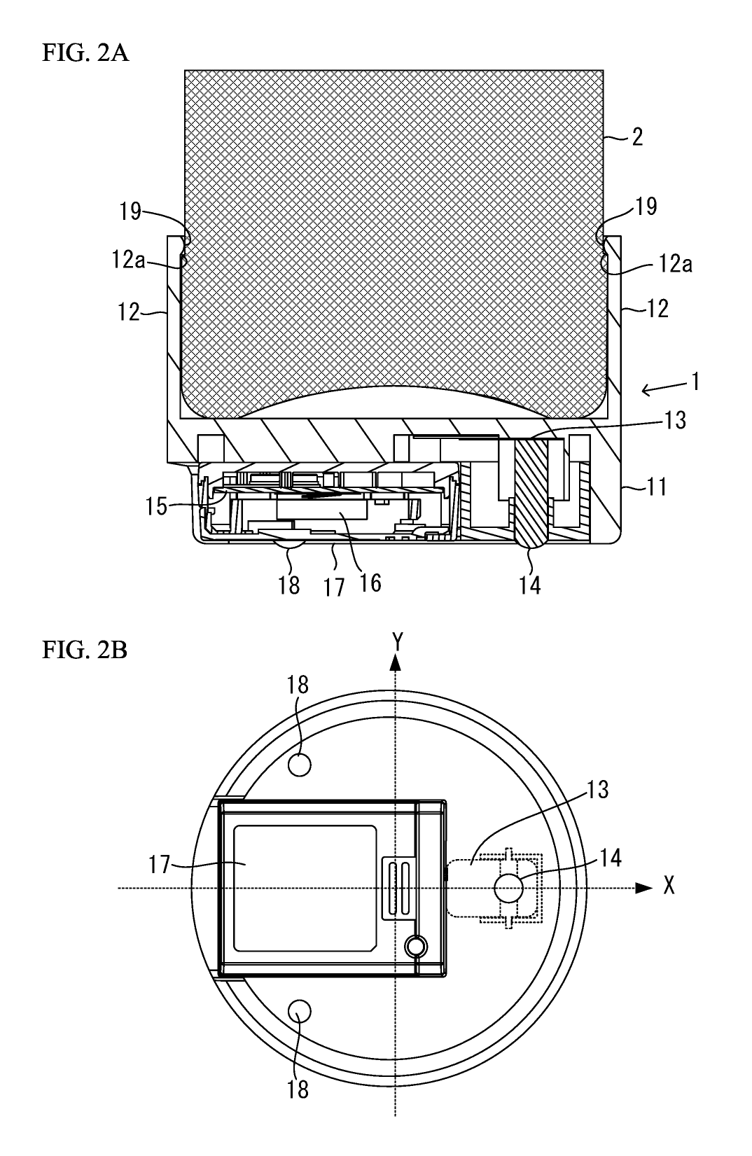

FIG. 2A is a cross-sectional view of the intake measuring device 1, and FIG. 2B is a bottom view of the intake measuring device 1 as viewed from below.

As illustrated in FIG. 2A, the intake measuring device 1 includes a chassis 11, a holding unit 12 as a holding device that detachably holds the container 2, a pressure sensor 13 that measures the weight of the container 2, a pusher 14 that transmits power to the pressure sensor 13 when the intake measuring device 1 is put on a table or the like, a control board 15 including a communication module and various sensors, a battery 16 that supplies electric power to the communication module and the various sensors, and a cover 17 that covers the battery 16. The pressure sensor 13 is electrically connected to the control board 15. The “weight of the container” means the weight including the tare weight, i.e., the sum of the weight of the container and the weight of the measured object in the container. However, the net weight can be calculated by subtracting the tare weight from the measured weight. For convenience sake, the “weight of the container” includes various weights such as the net weight of the measured object, which can be used to calculate the intake.

The pusher 14 protrudes from the bottom surface of the chassis 11. As illustrated in FIG. 2B, two supporting legs 18 are formed on the bottom surface of the chassis 11, and the intake measuring device 1 is three-point supported by the two supporting legs 18 and the pusher 14. Thus, the pusher 14 also functions as a supporting leg. In FIG. 2B, to present the positional relationship between the pressure sensor 13 and the pusher 14, the pressure sensor 13 is illustrated with dashed lines. When the pusher 14 and the pressure sensor 13 are arranged in the center of the intake measuring device 1, the pusher 14 may be in contact with the battery, or the pressure sensor 13 may interfere with the battery. Thus, a large-capacity battery cannot be employed. In the present embodiment, the position where the pusher 14 pushes the pressure sensor 13 is offset from the center of the intake measuring device 1 or the center of the container 2. This structure reduces the size of the intake measuring device 1 and enables to employ a large-capacity battery.

In the present embodiment, to discern the tilt of the container, the container is three-point supported. In the above example, one pusher 14 is provided, but the pushers may be separately arranged at three points, and the pressure may be measured at the three points.

The control board 15 and the battery 16 may be arranged in the center of the intake measuring device 1 as viewed from above. In this case, the weight balance of the container 2 to which the intake measuring device 1 is attached is not localized, and the container 2 to which the intake measuring device 1 is attached can be stably held easily.

The holding unit 12 is formed in a cylindrical shape, and has a circular shape as viewed from above, but the holding unit 12 may have a rectangular shape or a polygonal shape as long as the holding unit 12 can accommodate the container 2. A protruding portion 19 that engages with a recess portion of the container 2 is formed in the upper end of the holding unit 12. The engagement of the protruding portion 19 with the recess portion inhibits the container 2 from easily falling off from the holding unit 12. Although depending on the container, the height of the holding unit 12 is preferably 1 to 5 cm from the bottom surface of the container 2, for example. This is because the removal of the intake measuring device 1 becomes difficult when the holding unit 12 has a height covering the entire of the side surface of the container 2, while the intake measuring device 1 is not stably fixed to the container 2 when the holding unit 12 has a height covering only the lower part of the container 2.

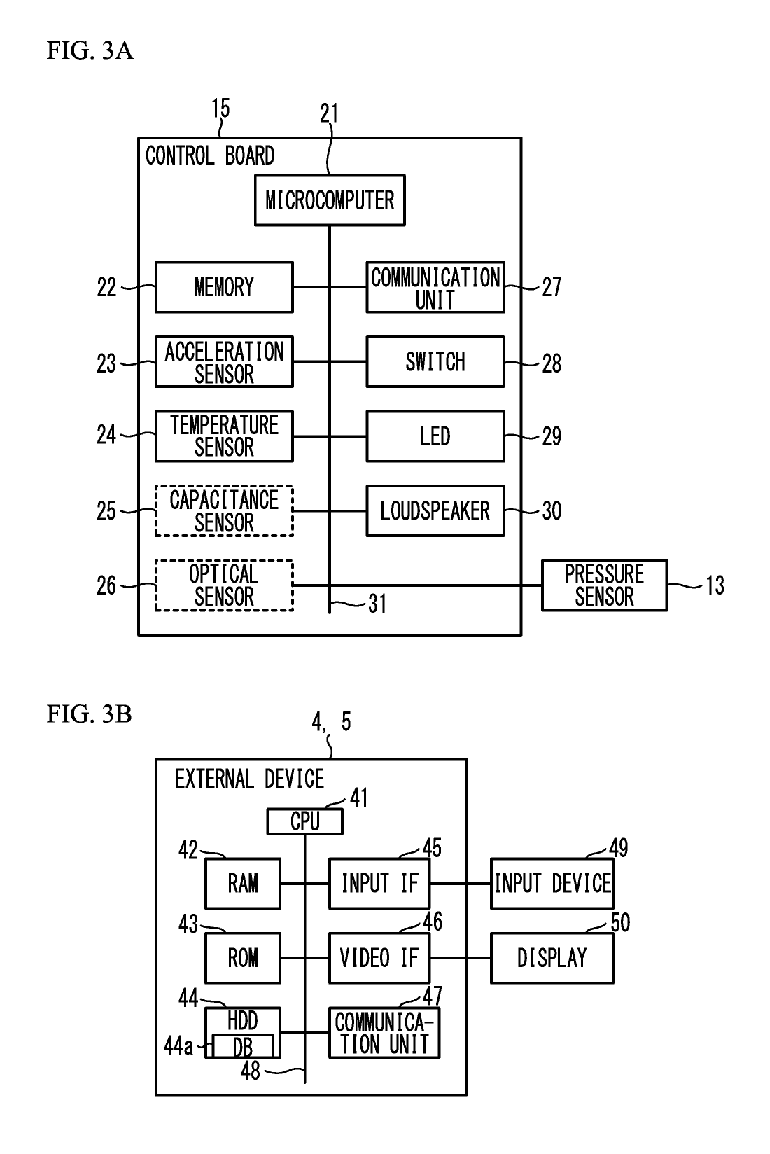

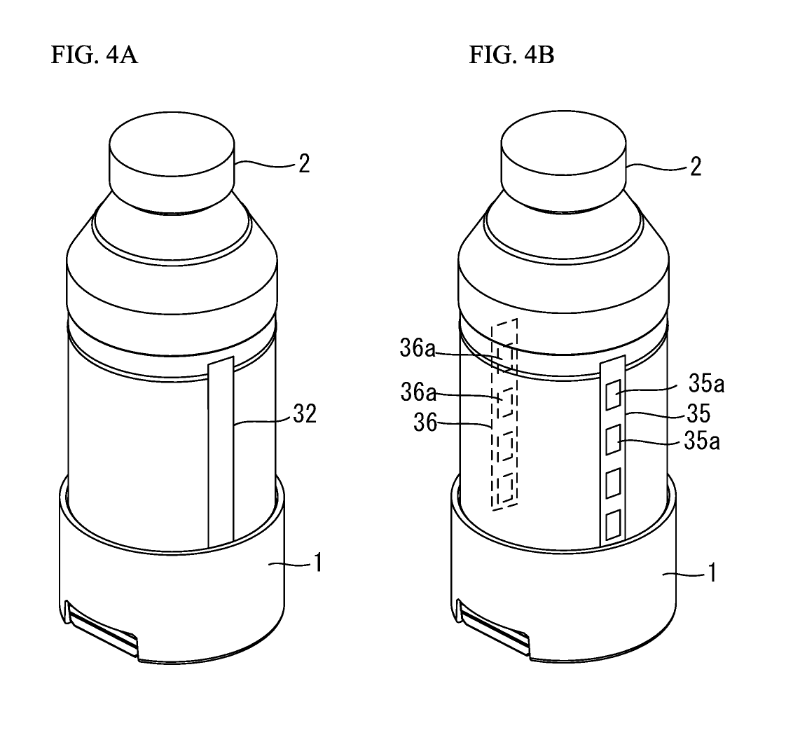

FIG. 3A is a configuration diagram of the control board 15, and FIG. 3B is a configuration diagram of the external terminal 4. The configuration of the external terminal 5 is the same as or similar to the configuration of the external terminal 4, and thus, the description thereof is omitted. FIG. 4A illustrates the state of the container 2 when a capacitance sensor 25 is used. FIG. 4B illustrates the state of the container 2 when an optical sensor 26 is used.

As illustrated in FIG. 3A, the control board 15 includes a microcomputer 21 as a calculation unit, which controls the operation of the intake measuring device 1 and calculates the intake of the measured object, a memory 22 that stores a program for calculating the intake of the measured object and various data, an acceleration sensor 23 that measures a tilt of the intake measuring device 1, a temperature sensor 24 that measures temperature around the intake measuring device 1, the capacitance sensor 25 that measures the liquid level of the measured object, the optical sensor 26 that measures the liquid level of the measured object, a communication unit 27 as a communication device that communicates with the external terminals 4 and 5 via the network 3, a switch 28 that detects fixing of the container 2 to the holding unit 12, an LED 29 as a warning unit that issues a warning by lighting or blinking, and a loudspeaker 30 as a warning unit that issues a warning by sound. The microcomputer 21 is coupled to the memory 22, the acceleration sensor 23, the temperature sensor 24, the capacitance sensor 25, the optical sensor 26, the communication unit 27, the switch 28, the LED 29, and the loudspeaker 30 through a bus 31. The pressure sensor 13 is coupled to the bus 31. The microcomputer 21 functions as a first correcting unit and a second correcting unit.

The communication unit 27 is a communication module for wireless communication or wired communication. The microcomputer 21 calculates the weight of the container 2 based on the output voltage of the pressure sensor 13, the temperature measured by the temperature sensor 24, and the data defining the relationship among the temperature, the output voltage, and the weight. The microcomputer 21 calculates the intake of the measured object based on the difference between the weight of the entire of the container 2 before ingestion of the measured object and the weight of the entire of the container 2 after the ingestion of the measured object. The data defining the relationship among the temperature, the output voltage, and the weight is stored in the memory 22 in advance. Additionally, the microcomputer 21 corrects the calculated weight of the container 2 based on the tilt of the intake measuring device 1 measured by the acceleration sensor 23.

It is sufficient if the intake measuring device 1 includes one of the pressure sensor 13, the capacitance sensor 25, and the optical sensor 26. When the capacitance sensor 25 or the optical sensor 26 is provided, the microcomputer 21 calculates the liquid level of the measured object in the container 2, i.e., the volume of the measured object, based on the output voltage of the capacitance sensor 25 or the optical sensor 26, the temperature measured by the temperature sensor 24, and data defining the relationship among the temperature, the output voltage, and the liquid level. Then, the microcomputer 21 calculates the intake of the measured object based on the difference between the volume of the measured object before ingestion and the volume of the measured object after the ingestion. The data defining the relationship among the temperature, the output voltage, and the liquid level is stored in the memory 22 in advance. In addition, the microcomputer 21 corrects the calculated volume of the measured object based on the tilt of the intake measuring device 1 measured by the acceleration sensor 23.

When the capacitance sensor 25 is used, as illustrated in FIG. 4A, a Flexible Printed Circuit (FPC) 32 for measuring the capacitance of the container 2 is attached to the side surface of the container 2. The FPC 32 includes a plurality of electrodes for measuring a liquid level, and is connected to the capacitance sensor 25. The capacitance sensor 25 converts a change in capacitance into a voltage, and outputs the voltage. The microcomputer 21 measures the volume of the measured object based on the output voltage of the capacitance sensor 25, and the data defining the relationship between the voltage and the liquid level. The data defining the voltage and the liquid level is stored in the memory 22 in advance.

When the optical sensor 26 is used, as illustrated in FIG. 4B, a tape 35 in which a plurality of light emitting devices 35a are vertically arranged and a tape 36 in which a plurality of light receiving devices 36a are vertically arranged are attached to the side surface of the container 2. The optical sensor 26 is electrically connected to the light emitting devices 35a and the light receiving devices 36a, and the microcomputer 21 measures the liquid level based on the outputs from the light receiving devices 36a.

As illustrated in FIG. 3B, the external terminal 4 includes a CPU 41 configured to control the operation of the external terminal 4, a RAM 42 functioning as a working area, a ROM 43 and a hard disk drive (HDD) 44 that store various data and programs, an input interface (IF) 45 to which an input device 49 such as a keyboard or a mouse is connected, a video IF 46 to which a display 50 is connected, and a communication unit 47 communicating with the intake measuring device 1 and the external terminal 5 via the network 3. The CPU 41 is coupled to the RAM 42, the ROM 43, the HDD 44, the input IF 45, the video IF 46, and the communication unit 47 through a bus 48. The CPU 41 and the communication unit 47 function as a warning notification unit.

The input device 49 and the display 50 may be built into the external terminal 4. The communication unit 47 is a communication module for wireless communication or wired communication. The HDD 44 includes a database 44a in which the measurement result of the intake is recorded together with the reception date and time of the measurement result, and the address of the intake measuring device 1 as described later. Additionally, when not receiving the measurement result of the intake of the measured object within a period during which the measurement result recorded in the database 44a is to be received (i.e., a dosing interval specified by directions), the CPU 41 transmits a warning signal to the intake measuring device 1 and the external terminal 5 via the network 3 to warn of forgetting to drink the measured object.

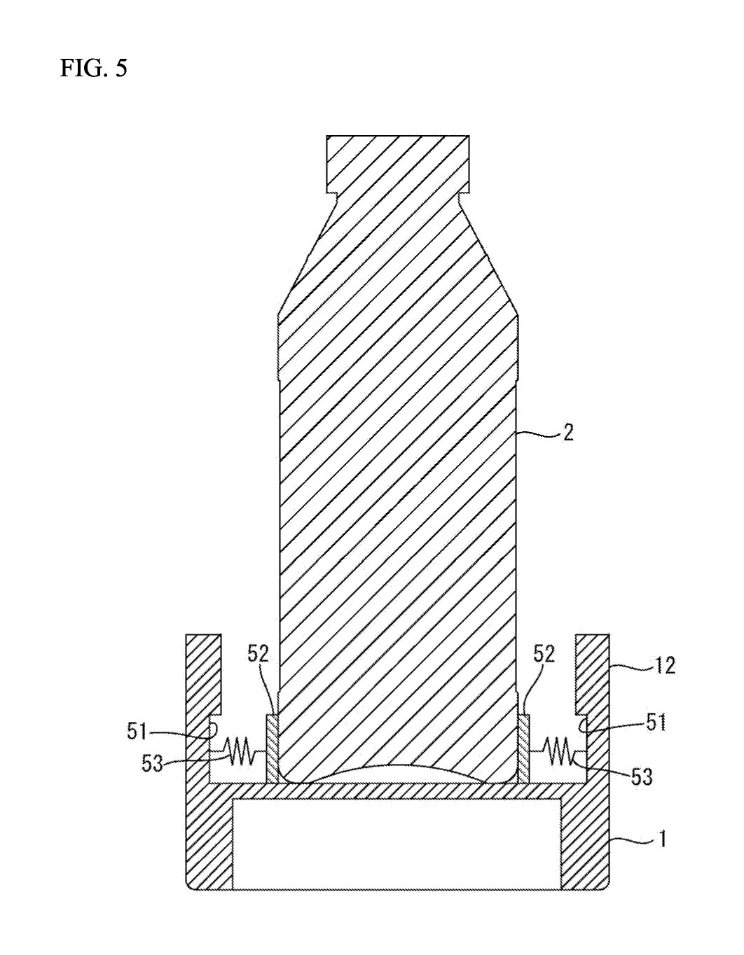

FIG. 5 is a schematic view of a cross-section of the intake measuring device 1. In FIG. 5, illustration of the pressure sensor 13, the pusher 14, the control board 15, and the battery 16 is omitted.

As illustrated in FIG. 5, the intake measuring device 1 may include a fixing unit 52 that can slide in the horizontal direction and fixes the container 2. In this case, the holding unit 12 includes a recess portion 51 accommodating the fixing unit 52. A spring 53 as a biasing unit that biases the fixing unit 52 toward the center of the intake measuring device 1 or the container 2 is connected between the recess portion 51 and the fixing unit 52. This structure allows the intake measuring device 1 to be fixed to the container 2 having a diameter less than the inner diameter of the holding unit 12.

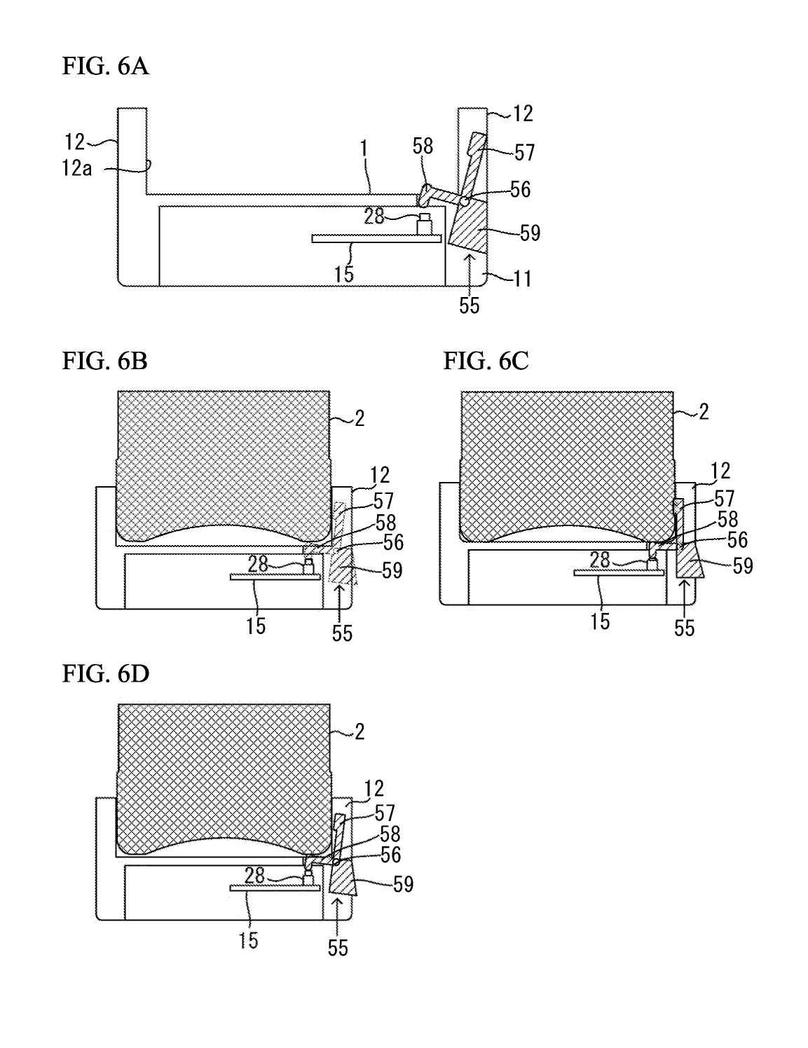

FIG. 6A is a schematic cross-sectional view of a first variation of the intake measuring device 1. FIG. 6B through FIG. 6D illustrate the state of a rotary holding member 55 from the mounting of the container 2 to the removal of the container 2. In FIG. 6A through FIG. 6D, illustration of the pressure sensor 13, the pusher 14, and the battery 16 is omitted.

As illustrated in FIG. 6A, the intake measuring device 1 includes the rotary holding member 55 rotatably mounted to the inside of the chassis 11. The rotary holding member 55 is rotatable around a rotary shaft 56 mounted to the inside of the chassis 11, and includes: a first arm portion 57 that protrudes from the inner wall 12a of the holding unit 12 toward the container 2 as the rotary holding member 55 rotates when the container 2 is inserted into the holding unit 12 and fixes the container 2; a second arm portion 58 that presses a switch 28 as the rotary holding member 55 rotates when the container 2 is inserted into the holding unit 12; and a pushed portion 59 that is pushed when the container 2 is removed from the holding unit 12.

When the container 2 is inserted into the holding unit 12 as illustrated in FIG. 6B, the container 2 presses the second arm portion 58 downward, and the rotary holding member 55 rotates counterclockwise. The rotation of the rotary holding member 55 causes the pushed portion 59 to protrude to the outside of the chassis 11 as illustrated in FIG. 6C, the second arm portion 58 thereby presses the switch 28, and the first arm portion 57 protrudes from the inner wall 12a of the holding unit 12 to the side surface of the container 2, and fixes the container 2. When the second arm portion 58 presses the switch 28, the switch 28 outputs a measurement start signal for measuring the weight of the container 2 or the liquid level to the microcomputer 21, and the microcomputer 21 starts calculating the intake of the measured object.

As illustrated in FIG. 6D, when the pushed portion 59 protruding from the holding unit 12 is pushed, the rotary holding member 55 rotates clockwise and releases the fixing of the container 2 by the first arm portion 57, and the second arm portion 58 separates from the switch 28 and presses up the bottom surface of the container 2. Accordingly, the container 2 can be removed from the holding unit 12. In addition, when the switch 28 separates from the second arm portion 58, the switch 28 outputs a measurement end signal for terminating the measurement of the weight of the container 2 or the liquid level to the microcomputer 21, and the microcomputer 21 terminates calculating the intake of the measured object.

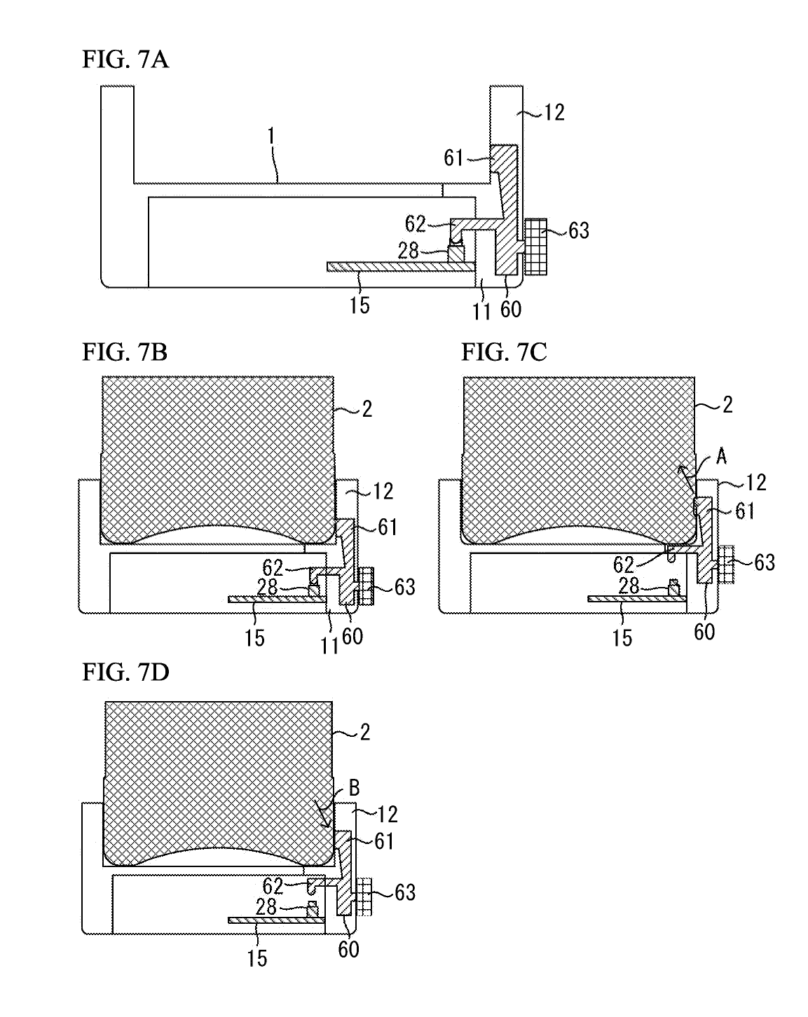

FIG. 7A is a schematic cross-sectional view of a second variation of the intake measuring device 1. FIG. 7B through FIG. 7D illustrate the state of a sliding holding member 60 from the mounting of the container 2 to the removal of the container 2. In FIG. 7A through FIG. 7D, illustration of the pressure sensor 13, the pusher 14, and the battery 16 is omitted.

As illustrated in FIG. 7A, the intake measuring device 1 includes the sliding holding member 60 that is mounted to the inside of the chassis 11 so as to be slidable in the vertical direction in the drawing. The sliding holding member 60 includes an operation unit 63 that is moved upward when the container 2 is fixed to the holding unit 12 and is moved downward when the container 2 is removed from the holding unit 12, a third arm portion 61 that moves obliquely upward to protrude from the inner wall 12a of the holding unit 12 to the container 2 and fixes the container 2 when the operation unit 63 is moved upward, and a fourth arm portion 62 that presses the switch 28 when the operation unit 63 is moved downward, and separates from the switch 28 when the operation unit 63 is moved upward.

First, as illustrated in FIG. 7B, the container 2 is inserted into the holding unit 12. At this time, the fourth arm portion 62 is pressing the switch 28. As illustrated in FIG. 7C, when a user moves the operation unit 63 upward, the third arm portion 61 moves obliquely upward (in the A direction) to protrude from the inner wall 12a of the holding unit 12 to the container 2, and then fixes the container 2. At the same time, the fourth arm portion 62 separates from the switch 28, the switch 28 outputs a measurement start signal for measuring the weight of the container 2 or the liquid level to the microcomputer 21, and the microcomputer 21 starts calculating the intake of the measured object.

As illustrated in FIG. 7D, when the operation unit 63 is moved downward, the third arm portion 61 moves obliquely downward (in the B direction) so as to be accommodated in the holding unit 12, and releases the fixing of the container 2. Accordingly, the container 2 can be removed from the holding unit 12. Then, when the operation unit 63 is moved to the lowest point, the fourth arm portion 62 presses the switch 28, the switch 28 outputs a measurement end signal for terminating the measurement of the weight of the container 2 or the liquid level to the microcomputer 21, and the microcomputer 21 terminates calculating the intake of the measured object.

When the intake measuring device 1 includes the rotary holding member 55 or the sliding holding member 60, the protruding portion 19 illustrated in FIG. 2A may be formed in the upper end of the holding unit 12, or may not be necessarily formed.

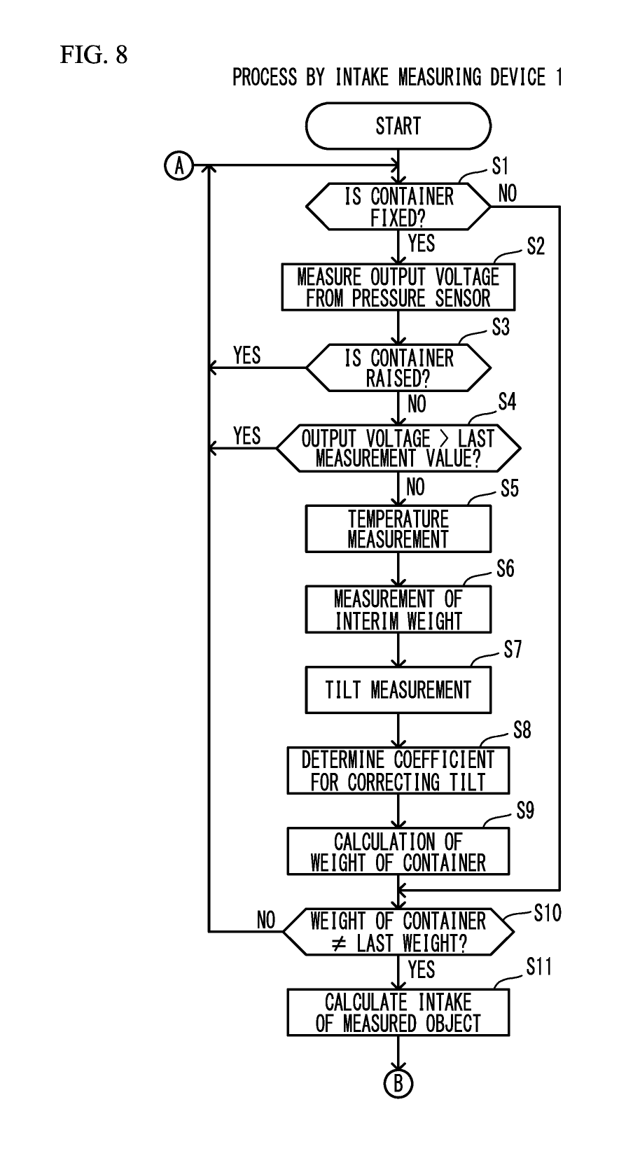

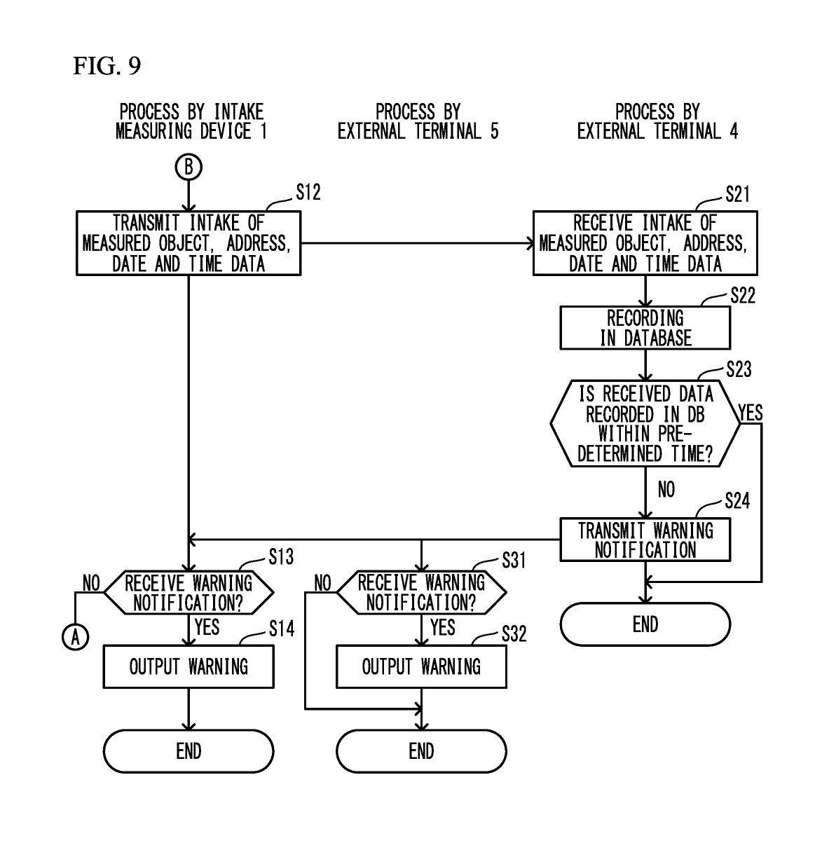

FIG. 8 and FIG. 9 are flowcharts illustrating processes executed by the intake measuring device 1 and the external terminals 4 and 5.

First, the microcomputer 21 determines whether the container 2 is fixed to the holding unit 12 based on the signal from the switch 28 (S1). When the intake measuring device 1 does not include the switch 28, or the rotary holding member 55 or the sliding holding member 60 pressing a switch, step S1 is skipped, and the process starts from step S2.

When the container 2 is not fixed to the holding unit 12 (S1/NO), the process moves to step S10 described later. When the container 2 is fixed to the holding unit 12 (S1/YES), the microcomputer 21 measures the output voltage of the pressure sensor 13 (S2).

The microcomputer 21 determines whether the container 2 to which the intake measuring device 1 is attached is raised based on the output voltage from the pressure sensor 13 (S3). When the container 2 is raised, the pusher 14 does not push the pressure sensor 13. Thus, the output voltage from the pressure sensor 13 becomes 0 V. When the container 2 is raised (S3/YES), it is considered that the user is ingesting the measured object. Thus, the weight of the container 2 is not measured, and the process returns to step S1.

When the container 2 is not raised (S3/NO), it is determined whether the output voltage from the pressure sensor 13 has increased from the last measurement value (S4). When the container 2 to which the intake measuring device 1 is attached is put on a table or the like, an acceleration is applied to the container 2. Thus, the output voltage of the pressure sensor 13 is compared with the last measurement value to determine whether the output voltage of the pressure sensor 13 has temporarily increased due to the shock generated when the container 2 was put.

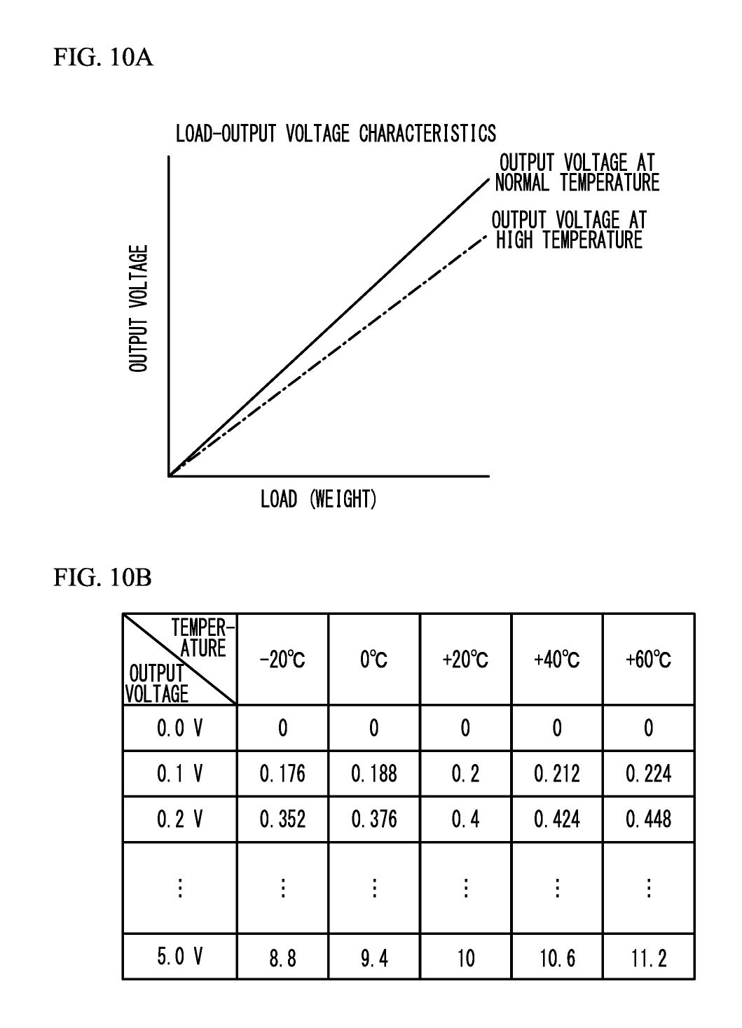

When the output voltage from the pressure sensor 13 has increased from the last measurement value (S4/YES), it is determined that the output voltage from the pressure sensor 13 has temporarily increased due to the shock. The process then returns to step S1 assuming that the container 2 was put on a table or the like. On the other hand, when the output voltage from the pressure sensor 13 is equal to or less than the last value (S4/NO), the microcomputer 21 discerns the output voltage from the temperature sensor 24, and measures the temperature (S5). As illustrated in FIG. 10A, since the load-output voltage characteristics of the pressure sensor 13 change according to temperature. Thus, the temperature is measured to measure the weight precisely.

The microcomputer 21 measures the interim weight of the container 2 based on table data that is stored in the memory 22 in advance and defines the relationship among the output voltage, the temperature, and the weight, the output voltage from the pressure sensor 13, and the temperature measured by the temperature sensor 24 (S6). At step S6, the interim weight of the container 2 is not measured based on only the output voltage of the pressure sensor 13, but is corrected based on the temperature. An example of the table data defining the relationship among the output voltage, the temperature, and the weight is illustrated in FIG. 10B. For example, when the output voltage of the pressure sensor 13 is 0.1 V and the measured temperature is +20° C., the weight is “0.2”. The weight of 0.1 represents 10 grams. Thus, “0.2” corresponds to 20 grams. Then, the microcomputer 21 measures the tilt of the intake measuring device 1, i.e., the tilt of the container 2, with use of the output of the acceleration sensor 23 (S7).

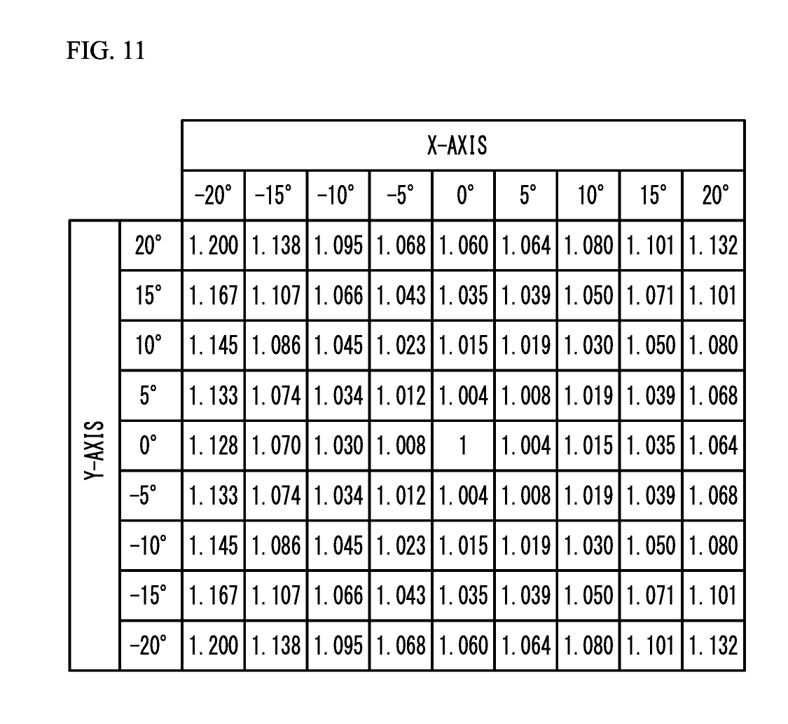

The microcomputer 21 determines a coefficient for correcting a tilt based on coefficient data for correcting a tilt that is stored in the memory 22 in advance illustrated in FIG. 11 and the tilt of the intake measuring device 1 measured at S7 (S8). In the coefficient data in FIG. 11, the correction amount for the weight is set with respect to the tilt in the X-axis direction and the tilt in the Y-axis direction of the container 2 with respect to the horizontal plane. The X-axis in FIG. 11 corresponds to the tilt of the container 2 in the X-axis direction in FIG. 2B with respect to the horizontal plane, and the Y-axis in FIG. 11 corresponds to the tilt of the container 2 in the Y-axis direction in FIG. 2B with respect to the horizontal plane. The microcomputer 21 calculates the weight of the container 2 by multiplying the interim weight of the container 2 measured at S6 by the coefficient for correcting a tilt determined at S8 (S9). The data on the calculated weight of the container 2 is stored in the memory 22. The processes at S8 and S9 enable to precisely calculate the weight of the container 2 even when the intake measuring device 1 attached to the container 2 is placed in an inclined place.

The reason why the weight is corrected according to the tilt of the container 2 is because the pusher 14 is offset from the center of the container 2, and thereby, the pressure applied to the pressure sensor 13 through the pusher 14 varies according to the tilt of the container 2. In FIG. 11, when the absolute values of the angles of tilt in the Y-axis direction of the container 2 with respect to the horizontal plane are the same (for example, 5° and −5°, 10° and −10°), the correction amount for the negative angle is equal to the correction amount for the positive angle. On the other hand, when the absolute values of the angles of tilt in the X-axis direction of the container 2 with respect to the horizontal plane are the same, the correction amount for the negative angle is greater than the correction amount for the positive angle.

Then, the microcomputer 21 determines whether the weight of the container 2 calculated at S9 differs from the weight of the container 2 calculated last time (S10). The data on the weight of the container 2 calculated last time is stored in the memory 22. When the weight of the container 2 calculated at S9 is equal to the weight of the container 2 calculated last time (S10/NO), it is determined that the measured object is not ingested, and the process returns to step S1.

When the weight of the container 2 calculated at S9 differs from the weight of the container 2 calculated last time (S10/YES), the microcomputer 21 calculates the difference between the weight calculated at S9 and the weight calculated last time as the intake of the measured object (S11). The communication unit 27 transmits data indicating the intake of the measured object to the external terminal 4 together with the address of the intake measuring device 1 and date and time data (S12). The communication unit 27 may additionally transmit the user name and the identifier of the intake measuring device 1 to the external terminal 4.

The external terminal 4 receives from the intake measuring device 1 the data indicating the intake of the measured object, the address of the intake measuring device 1, and date and time data (S21), and the CPU 41 records the intake of the measured object, the address of the intake measuring device 1, and the date and time at which the intake was measured in the database 44a (S22).

The CPU 41 determines whether the received data from the intake measuring device 1 is recorded in the database 44a within a predetermined period of time from the last data recording, i.e., within the dosing interval specified by directions (S23). At this step, the CPU 41 determines whether ingestion of the measured object is forgotten. When the data received from the intake measuring device 1 is recorded in the database 44a within a predetermined time from the last data recording (S23/YES), the process is terminated. On the other hand, when the data received from the intake measuring device 1 is not recorded in the database 44a within a predetermined time from the last data recording (S23/NO), the CPU 41 transmits a warning notification to the intake measuring device 1 and the external terminal 5 through the communication unit 47 to give notice of forgetting to drink the measured object (S24). Here, the external terminal 5 is, for example, the mobile terminal of the user, user's family, or a hospital official such as a nurse.

In the above description, since the weight of the measured object is measured, the overage or shortage of the intake with respect to the amount of the measured object to be ingested may be warned to the user. Additionally, not only managing the intake but also managing the remaining amount of the measured object is possible, and it is possible to issue a warning when the remaining amount becomes small. The remaining amount of the measured object is calculated by subtracting the weight of the empty container 2 from the weight of the container 2 calculated at S9 by the microcomputer 21. The weight of the empty container 2 is stored in the memory 22 in advance. The communication unit 27 transmits data indicating the remaining amount of the measured object to the external terminal 4 together with the address of the intake measuring device 1 and date and time data.

The microcomputer 21 of the intake measuring device 1 determines whether a warning notification has been received from the external terminal 4 (S13). When a warning notification has been received (S13/YES), the microcomputer 21 outputs a warning to report that ingestion of the measured object has been forgotten by lighting or blinking the LED 29 or emitting sound from the loudspeaker 30 (S14), and ends the process. When a warning notification is not received (S13/NO), the process returns to step S1. The process at S14 allows to notify the user of a warning, and prevents ingestion of the measured object from being forgotten.

The external terminal 5 determines whether a warning notification has been received from the external terminal 4 (S31). When a warning notification has been received (S31/YES), the external terminal 5 outputs a warning from the display 50 or a loudspeaker not illustrated (S32). When a warning notification is not received (S31/NO), the process is ended. The process at S32 allows to notify the user of a warning of forgetting to drink the measured object.

In FIG. 8 and FIG. 9, the intake of the measured object is calculated with use of the pressure sensor 13, but the intake of the measured object may be calculated with use of the capacitance sensor 25 or the optical sensor 26.

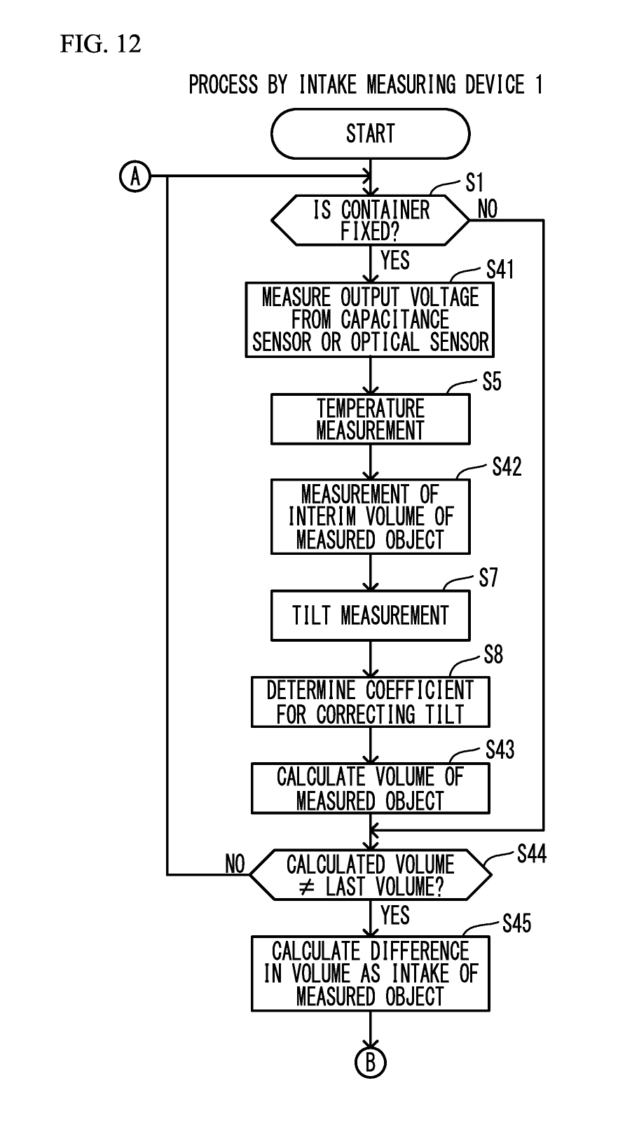

FIG. 12 is a flowchart of a process executed by the intake measuring device 1 using the capacitance sensor 25 or the optical sensor 26. The same step numbers are affixed to the same processes as those of the flowchart in FIG. 8, and the description thereof is omitted.

When the container 2 is not fixed to the holding unit 12 (S1/NO), the process moves to step S44 described later. When the container 2 is fixed to the holding unit 12 (S1/YES), the microcomputer 21 measures the output voltage from the capacitance sensor 25 or the output voltage from the optical sensor 26 (S41). After the process at S41, the process moves to step S5.

The microcomputer 21 measures the interim volume of the measured object based on the table data defining the relationship among the output voltage, the temperature, and the liquid level stored in the memory 22 in advance, the output voltage from the capacitance sensor 25 or the optical sensor 26, and the temperature measured by the temperature sensor 24 (S42), and moves to step S7. At step S42, the interim volume is not measured only based on the output voltage of the capacitance sensor/optical sensor, but is corrected based on the temperature. The microcomputer 21 calculates the volume of the measured object by multiplying the interim volume measured at S42 by the coefficient for correcting a tilt determined at S8 (S43). The data on the calculated volume of the measured object is stored in the memory 22.

Then, the microcomputer 21 determines whether the volume of the measured object calculated at S43 differs from the volume of the measured object calculated last time (S44). The volume of the measured object calculated last time is stored in the memory 22. When the volume of the measured object calculated at S43 is equal to the volume of the measured object calculated last time (S44/NO), the process returns to step S1.

When the volume of the measured object calculated at S43 differs from the volume of the measured object calculated last time (S44/YES), the microcomputer 21 calculates the difference between the volume of the measured object calculated at S43 and the volume of the measured object calculated last time as the intake of the measured object (S45). Thereafter, the process moves to step S12 in FIG. 9.

As described above, in the present embodiment, the intake measuring device 1 includes the holding unit 12 that holds the container 2 detachably, various sensors that measure the weight of the container 2 or the volume of the measured object, the microcomputer 21 configured to calculate the intake of the measured object based on the last measurement result and the weight of the container or the volume of the measured object measured by the sensor, and the communication unit 27 configured to transmit the intake of the measured object to the external terminal. After the measured object in the container 2 is completely drunk, the empty container 2 can be removed from the holding unit 12 and disposed. Thus, a burdensome task such as washing of the container 2 becomes unnecessary. Additionally, since the data indicating the measured intake of the measured object is transmitted to the external terminal, the intake of the measured object can be managed with use of the external terminal. That is, the user does not need to manage the intake of the measured object by himself, the management of the intake of the measured object becomes easy.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A measuring device comprising:
a holding device that holds a container containing a measured object detachably;
a measuring unit that measures a weight of the container or a volume of the measured object;
a calculation unit configured to calculate an amount of use of the measured object based on the weight or the volume measured by the measuring unit and a last measurement result by the measuring unit; and
a communication device that transmits the amount of use of the measured object to an external terminal.

2. The measuring device according to claim 1, wherein
the holding device includes a protrusion for fixing the container.

3. The measuring device according to claim 1, further comprising:
a switch that outputs a measurement start signal to the measuring unit; and
a holding member including a first part that fixes the container to the holding device, and a second part that operates the switch according to fixing of the container to cause the switch to output the measurement start signal.

4. The measuring device according to claim 3, wherein
the fixing of the container by the first part is released by a release operation by an operator, and
the second part operates the switch according to release of the fixing of the container to cause the switch to output a measurement end signal to the measuring unit.

5. The measuring device according to claim 1, wherein
the measuring unit includes a first sensor measuring the weight of the container, and
the measuring device further comprises:
a chassis;
a supporting leg located on a bottom surface of the chassis; and
a pusher that is in contact with the first sensor and protrudes from the bottom surface of the chassis to function as a supporting leg.

6. The measuring device according to claim 1, wherein
the measuring unit includes a second sensor measuring the volume of the measured object.

7. The measuring device according to claim 1, further comprising:
a temperature measuring unit that measures temperature; and
a first correcting unit configured to correct the weight of the container or the volume of the measured object detected by the measuring unit based on a temperature measured by the temperature measuring unit.

8. The measuring device according to claim 1, further comprising:
a tilt measuring unit measuring a tilt of the measuring device; and
a second correcting unit configured to correct the weight of the container or the volume of the measured object measured by the measuring unit based on a tilt measured by the tilt measuring unit.

9. A measuring device comprising:
a holding device that holds a container containing a measured object detachably;
a measuring unit that measures a weight of the container;
a calculation unit configured to calculate a remaining amount of the measured object based on a weight measured by the measuring unit and a weight of the container when the container is empty; and
a communication device that transmits the remaining amount of the measured object to an external terminal.

10. A measuring system including a measuring device and an external terminal, wherein
the measuring device includes:
a holding device that holds a container containing a measured object detachably,
a measuring unit that measures a weight of the container or a volume of the measured object,
a calculation unit configured to calculate an intake of the measured object based on a last measurement result by the measuring unit and the weight of the measured object or the volume of the measured object measured by the measuring unit,
a communication device that transmits data indicating the intake of the measured object to the external terminal, and
a warning unit that outputs a warning when the communication device receives a warning notification from the external terminal, and
the external terminal includes:
a database in which the data indicating the intake of the measured object is recorded, and
a warning notification unit configured to transmit a warning notification to the measuring device when the data indicating the intake of the measured object is not recorded in the database within a predetermined time from last data recording.
